(19) United States
(12) Patent Application Publication
(10) Pub. No.: US 2008/0158283 A1
(43) Pub. Date: Jul. 3, 2008

(54) INKJET PRINTERS

(75) Inventors: Cheng-Lin Tsai, Taoyuan County (TW); Sheng-Hui Wu, Taipei County (TW); Shr-How Huang, Taipei City (TW)

Correspondence Address: QUINTERO LAW OFFICE, PC, 2210 MAIN STREET, SUITE 200, SANTA MONICA, CA, 90405, US

(73) Assignee: QISDA CORPORATION, TAOYUAN COUNTY (TW)

(21) Appl. No.: 11/967,596

(22) Filed: Dec. 31, 2007

(30) Foreign Application Priority Data
Jan. 2, 2007 (TW) TW96100039

(51) Int. Cl. B41J 29/38

(52) U.S. Cl. 347/20

(57) ABSTRACT

Inkjet printers are provided. An inkjet printer includes an ink tank, an inkjet unit, a first slider, and a cam mechanism. The inkjet unit includes a reservoir, and the reservoir has a first valve with the first slider movably connected thereto. Ink is transferred from the ink tank to the reservoir when the first valve is open. The cam mechanism includes a shaft and a first cam fixed thereto. When the cam mechanism rotates to a first position, the first cam impels the first slider in a first direction and opens the first valve.

### BACKGROUND OF THE INVENTION

1. Field of the Invention

The invention relates in general to printers and in particular to inkjet printers.

2. Description of the Related Art

Conventional inkjet printers commonly utilize inkjet cartridges typically including an ink tank and a print head integrated therewith. However, the integrated inkjet cartridges are costly and uneconomical because they can not be reusable and refilled with ink. Another type of inkjet printers utilize separate ink tank and print head. When the print head fails or the ink tank is empty, the ink tank and the print head can be replaced individually. To prevent replacement of the ink tank and the print head, continuous ink supply systems have become critical.

### BRIEF SUMMARY OF THE INVENTION

Inkjet printers are provided. An inkjet printer includes an ink tank, an inkjet unit, a first slider, and a cam mechanism. The inkjet unit includes a reservoir, and the reservoir has a first valve with the first slider movably connected thereto. Ink is transferred from the ink tank to the reservoir when the first valve is open. The cam mechanism includes a shaft and a first cam fixed thereto. When the cam mechanism rotates to a first position, the first cam impels the first slider in a first direction and opens the first valve.

### BRIEF DESCRIPTION OF THE DRAWINGS

The invention can be more fully understood by reading the subsequent detailed description and examples with references made to the accompanying drawings, wherein:

FIG. 1 is a perspective diagram of an inkjet printer;

FIGS. 2A-2D are perspective diagrams of first, second, third, and fourth cams of a cam mechanism when in a first position;

FIGS. 3A-3D are perspective diagrams of first, second, third, and fourth cams of a cam mechanism when in a second position;

FIGS. 4A-4D are perspective diagrams of first, second, third, and fourth cams of a cam mechanism when in a third position;

FIGS. 5A-5D are perspective diagrams of first, second, third, and fourth cams of a cam mechanism when in a fourth position;

FIGS. 6A-6D are perspective diagrams of first, second, third, and fourth cams of a cam mechanism when in a fifth position;

FIGS. 7A-7D are perspective diagrams of first, second, third, and fourth cams of a cam mechanism when in a sixth position;

FIG. 8A is a speed-time diagram of a cam mechanism; and

FIG. 8B is a torque-time diagram of a motor.

### DETAILED DESCRIPTION OF THE INVENTION

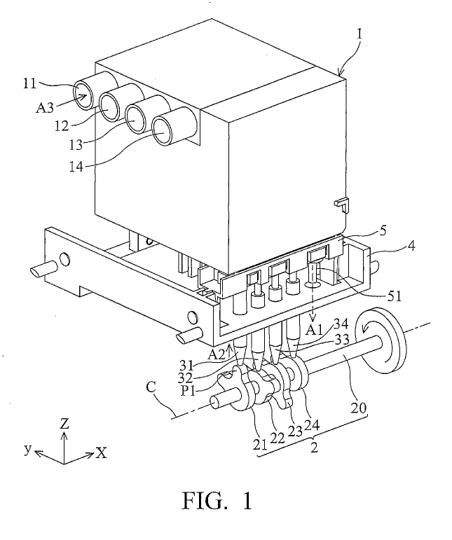

Referring to FIG. 1, an embodiment of an inkjet printer primarily comprises an inkjet unit 1, a cam mechanism 2, a first slider 31, a second slider 32, a third slider 33, a fourth slider 34, a carrier 4, a cap 5, and an ink tank (not shown). The inkjet unit 1 comprises an interior ink reservoir (not shown) partitioned into four chambers respectively accommodating cyan, magenta, yellow, and black inks. As shown in FIG. 1, the four color inks can be transferred from the ink tank to the reservoir through four conduits 11-14, respectively. In this embodiment, the inkjet unit 1 further comprises a print head (not shown) disposed on the bottom side thereof and communicated with the reservoir. When printing on a medium, such as a paper sheet, the inkjet unit 1 separates from the cap 5 and reciprocally moves along X axis.

When the reservoir lacks any one of the cyan, magenta, yellow, or black ink during printing, the inkjet unit 1 moves to the top of the 4 and joins with the cap 5, as shown in FIG. 1. Subsequently, a pneumatic pump (not shown) vacuums the reservoir through a passage 51 from bottom of the cap 5, as the arrow A1 indicates in FIG. 1, thus drawing a specific color ink from the ink tank to the reservoir without replacing the inkjet unit 1. In this embodiment, the first, second, third, and fourth sliders 31-34 are movably connected to a first, second, third, and fourth valve (not shown) from the bottom of the reservoir. The cam mechanism 2 can rotate and impel the sliders 31-34 along a first direction (Z direction) to open or close the four valves.

When the cam mechanism 2 impels the first slider 31 in the first direction, as the arrow A2 indicates in FIG. 1, the first valve is open. Hence, cyan ink is conducted from the ink tank through the conduit 11 to the reservoir of the inkjet unit 1 by the pneumatic pump, as the arrow A3 indicates in FIG. 1. Similarly, when the cam mechanism 2 impels the second slider 32 in the first direction, the second valve is open, such that magenta ink is conducted from the ink tank to the reservoir of the inkjet unit 1 through the conduit 12. When the cam mechanism 2 impels the third slider 33 in the first direction, the third valve is open, such that yellow ink is conducted from the ink tank to the reservoir of the inkjet unit 1 through the conduit 13. When the cam mechanism 2 impels the fourth slider 34 in the first direction, the fourth valve is open, such that black ink is conducted from the ink tank to the reservoir of the inkjet unit 1 through the conduit 14.

According to this embodiment, the cam mechanism 2 controls movement of the sliders 31-34 to open or close corresponding valves of the reservoir. Cam mechanism 2 in FIG. 1 primarily comprises a shaft 20, a first cam 21, a second cam 22, a third cam 23, and a fourth cam 24, corresponding to the four sliders 31-34. The cams 21-24 are fixed to the shaft 20 and rotated with the shaft 20 around a central axis C thereof parallel to X axis.

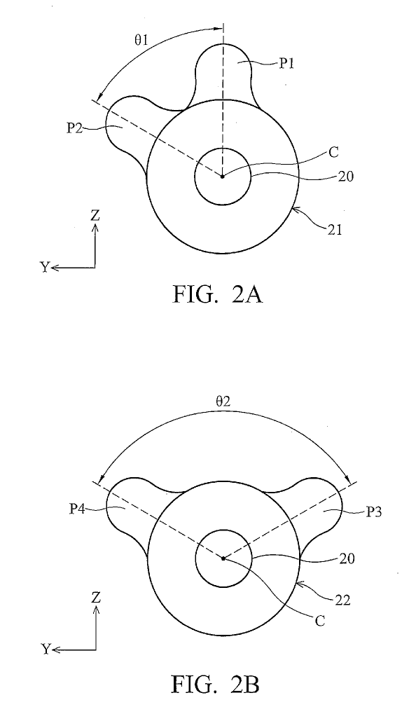

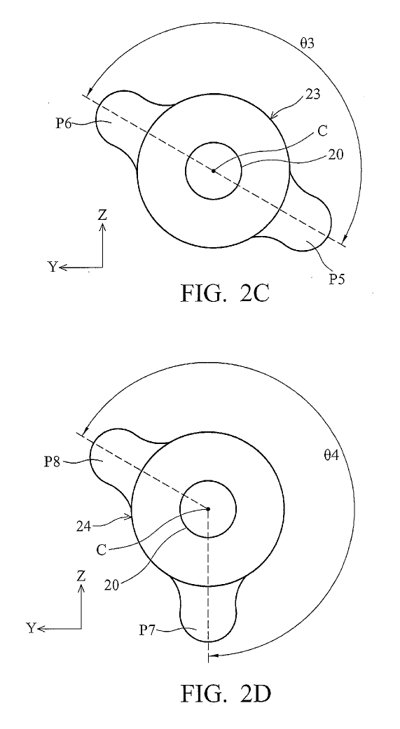

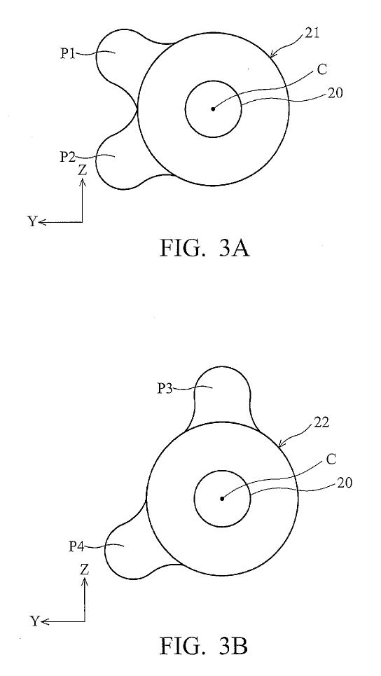

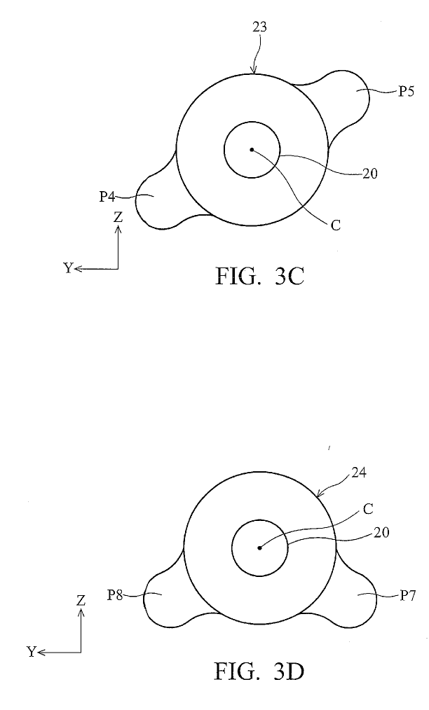

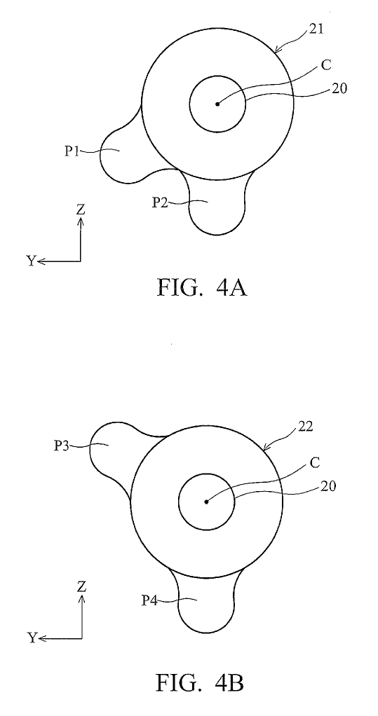

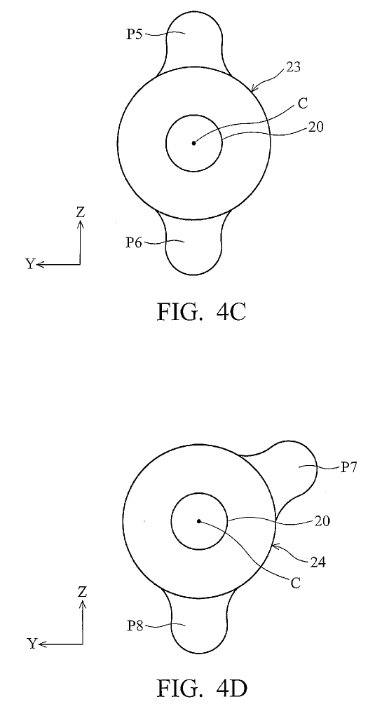

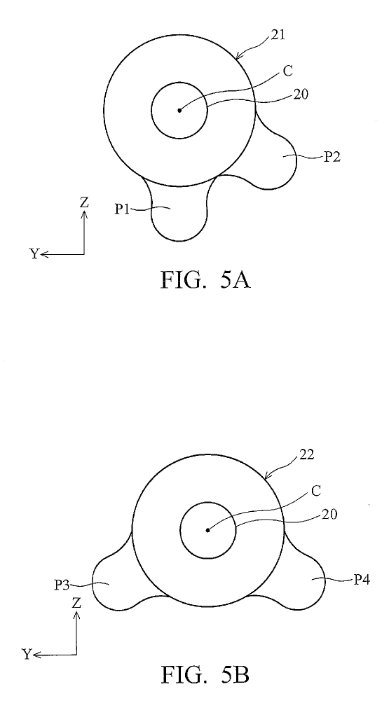

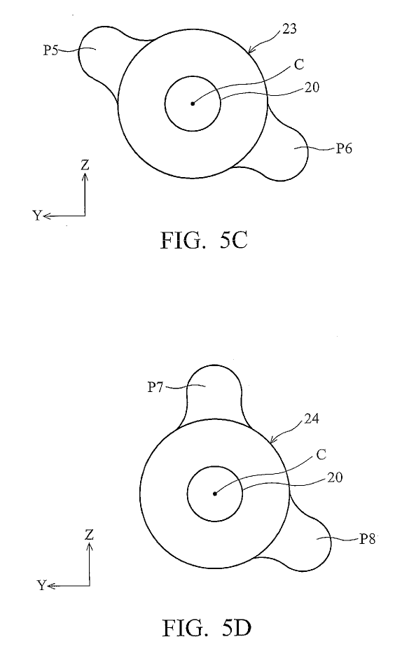

FIGS. 2A-2D depict detailed profiles of the four cams 21-24, respectively. As shown in FIGS. 2A-2D, the first cam 21 comprises a first protrusion P1 and a second protrusion P2, the second cam 22 comprises a third protrusion P3 and a fourth protrusion P4, the third cam 23 comprises a fifth protrusion P5 and a sixth protrusion P6, and the fourth cam 24 comprises a seventh protrusion P7 and a eighth protrusion P8. Here, the first and second protrusions P1 and P2 form an angle θ1 substantially 60°, the third and fourth protrusions P3 and P4 an angle θ2 substantially 120°, the fifth and sixth protrusions P5 and P6 an angle θ3 substantially 180°, and the seventh and eighth protrusions P7 and P8 an angle θ4 substantially 240°, wherein the second, fourth, sixth, and eighth protrusions P2, P4, P6, and P8 are oriented in the same direction.

When the cam mechanism 2 rotates around the central axis C to a first angle, as shown in FIG. 1, only the first protrusion P1 of the first cam 21 is oriented toward Z direction. Hence, the first protrusion P1 impels the first slider 31 upward and opens the first valve to conduct cyan ink into the reservoir. Similarly, when the cam mechanism 2 rotates to a second angle, only the third protrusion P3 of the second cam 22 is oriented toward Z direction and impels the second slider 32 upward, to open the second valve and conduct magenta ink into the reservoir. When the cam mechanism 2 rotates to a third angle, only the fifth protrusion P5 of the third cam 23 is oriented toward Z direction and impels the third slider 33 upward, to open the third valve and conduct yellow ink into the reservoir. When the cam mechanism 2 rotates to a fourth angle, only the seventh protrusion P7 of the fourth cam 24 is oriented toward Z direction and impels the fourth slider 34 upward, to open the fourth valve and conduct black ink into the reservoir.

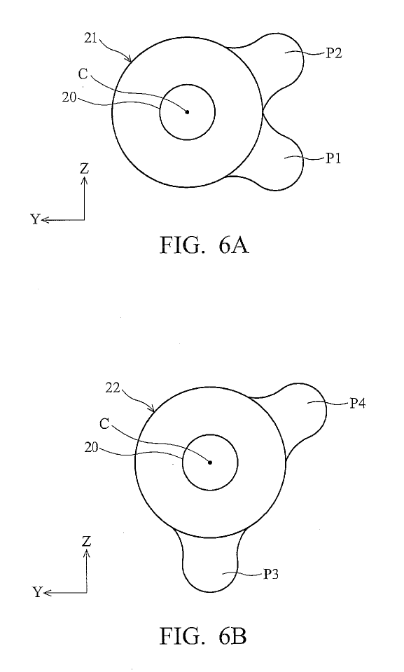

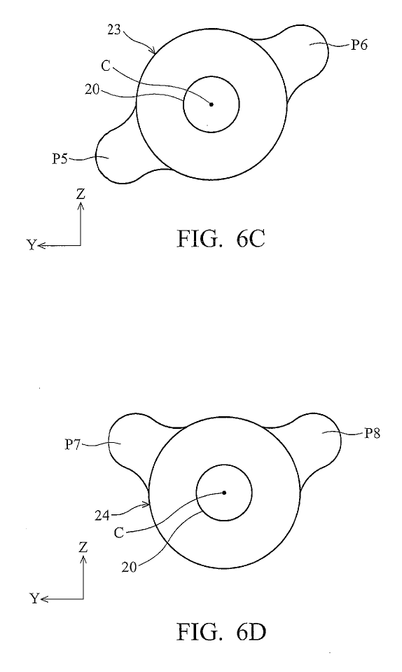

Furthermore, when the cam mechanism 2 rotates to a fifth angle, as shown in FIGS. 6A-6D, no protrusion is oriented toward Z direction. Namely, the first slider 31 separates from the first and second protrusions P1 and P2, the second slider 32 separates from the third and fourth protrusions P3 and P4, the third slider 33 separates from fifth and sixth protrusions P5 and P6, and the fourth slider 34 separates from the seventh and eighth protrusions P7 and P8, such that the four valves of the reservoir remain closed to stop ink supply from the ink tank.

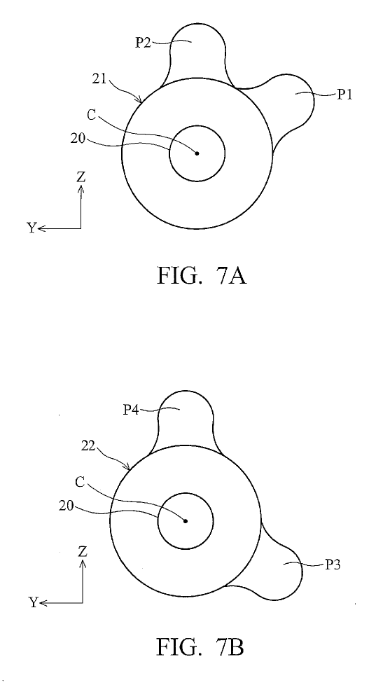

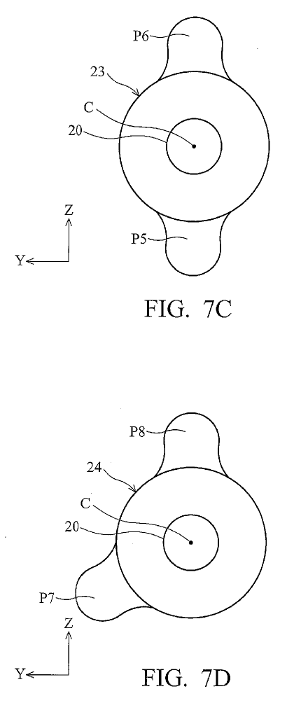

Referring to FIGS. 7A-7D, when the cam mechanism 2 rotates to a sixth angle, the second, fourth, sixth, and eighth protrusions P2, P4, P6, and P8 are oriented toward Z direction and simultaneously impel the sliders 31-34 upward, such that the four valves of the reservoir are open and allow cyan, magenta, yellow, and black inks into the reservoir.

As mentioned, the cam mechanism 2 can rotate to the first, second, third or fourth angle to selectively conduct cyan, magenta, yellow, or black ink into the reservoir. Moreover, the cam mechanism 2 can further rotate to the fifth or sixth angle to simultaneously open or close the four valves of the reservoir, wherein the first, second, third, and fourth, fifth and sixth angles are spaced substantially 60° apart.

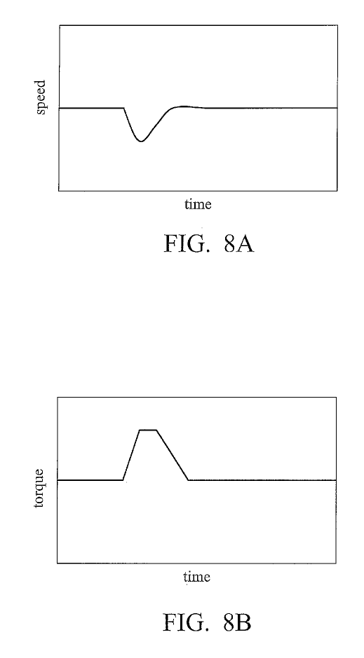

In some embodiments, the inkjet printer further comprises a motor (not shown) and a detection circuit (not shown). The motor rotates the cam mechanism 2 at a constant speed, and the detection circuit can detect position of the cam mechanism 2 according to variation of rotational speed of the cam mechanism 2 or driving torque of the motor. For example, when the motor rotates the cam mechanism 2 at a constant speed to the first angle, the first protrusion P1 of the first cam 21 impels the first slider 31 in Z direction. Here, the cam mechanism 2 sustains a resistant force from the first slider 31, wherein rotational speed thereof abruptly descends and driving toque of the motor arises, as shown in FIGS. 8A and 8B. Thus, position of the cam mechanism 2 can be determined by the detection circuit detecting the abrupt variation of rotational speed of the cam mechanism 2 or driving torque of the motor.

Specifically, when the cam mechanism 2 rotates to the sixth angle, the four protrusions P2, P4, P6, and P8 of the cams 21-24 simultaneously contact the four sliders 31-34 and sustain a lager resistant force. The detection circuit can detect and distinguish the sixth position from the other positions according to the intense variation of rotational speed or driving torque. In some embodiments, the sixth position can be defined as a reference position of the cam mechanism 2. Since detection of rotational speed and driving torque can be implemented by feedback control circuits integrated with the motor, no optical detector is required, reducing production cost and dimensions of the inkjet printer.

Inkjet printers are provided according to the embodiments. An inkjet printer utilizes a cam mechanism controlling different valves of an ink reservoir within an inkjet unit, facilitating individual replenishment of cyan, magenta, yellow, or black ink, reducing production cost and dimensions of the inkjet printer.

While the invention has been described by way of example and in terms of preferred embodiment, it is to be understood that the invention is not limited thereto. To the contrary, it is intended to cover various modifications and similar arrangements (as would be apparent to those skilled in the art). Therefore, the scope of the appended claims should be accorded the broadest interpretation so as to encompass all such modifications and similar arrangements.

What is claimed is:

1. An inkjet printer, comprising:
an ink tank;
a first slider;
an inkjet unit, comprising a reservoir and a print head communicating with the reservoir for printing on a medium, wherein the reservoir comprises a first valve with the first slider movably connected thereto, and ink is transferred from the ink tank to the reservoir when the first valve is open; and
a cam mechanism, comprising a shaft and a first cam fixed thereto, wherein when the cam mechanism rotates around a central axis thereof to a first position, the first cam impels the first slider in a first direction and opens the first valve.

2. The inkjet printer as claimed in claim 1, wherein the first direction is substantially perpendicular to the central axis.

3. The inkjet printer as claimed in claim 1, further comprising a pump connected to the inkjet unit, wherein when the first valve is open, the pump vacuums the reservoir and conducts ink from the ink tank to the reservoir.

4. The inkjet printer as claimed in claim 3, wherein cyan ink is conducted from the ink tank to the reservoir when the first valve is open.

5. The inkjet printer as claimed in claim 3, further comprising a second slider, the reservoir further comprising a second valve with the second slider movably connected thereto, the cam mechanism further comprising a second cam fixed to the shaft, wherein when the cam mechanism rotates around the central axis to a second position, the second cam impels the second slider in the first direction and opens the second valve.

6. The inkjet printer as claimed in claim 5, wherein red ink is conducted from the ink tank to the reservoir when the second valve is open.

7. The inkjet printer as claimed in claim 5, further comprising a third slider, the reservoir further comprising a third valve with the third slider movably connected thereto, the cam mechanism further comprising a third cam fixed to the shaft, wherein when the cam mechanism rotates around the central axis to a third position, the third cam impels the third slider in the first direction and opens the third valve.

8. The inkjet printer as claimed in claim 7, wherein yellow ink is conducted from the ink tank to the reservoir when the third valve is open.

9. The inkjet printer as claimed in claim 7, further comprising a fourth slider, the reservoir further comprising a fourth valve with the fourth slider movably connected thereto, the cam mechanism further comprising a fourth cam fixed to the shaft, wherein when the cam mechanism rotates around the central axis to a fourth position, the fourth cam impels the fourth slider in the first direction and opens the fourth valve.

10. The inkjet printer as claimed in claim 9, wherein black ink is conducted from the ink tank to the reservoir when the fourth valve is open.

11. The inkjet printer as claimed in claim 9, wherein when the cam mechanism rotates around the central axis to a fifth position, the first, second, third, and fourth valves are closed.

12. The inkjet printer as claimed in claim 11, wherein when the cam mechanism rotates around the central axis to a sixth position, the first, second, third, and fourth cams respectively impel the first, second, third, and fourth sliders in the first direction to open the first, second, third, and fourth valves.

13. The inkjet printer as claimed in claim 12, wherein the first, second, third, and fourth, fifth, and sixth positions are spaced substantially 60° apart.

14. The inkjet printer as claimed in claim 12, the first cam comprising a first protrusion and a second protrusion, the second cam comprising a third protrusion and a fourth protrusion, the third cam comprising a fifth protrusion and a sixth protrusion, the fourth cam comprising a seventh protrusion and a eighth protrusion;
wherein the first protrusion impels the first slider and opens the first valve when the cam mechanism rotates to the first position;
wherein the third protrusion impels the second slider and opens the second valve when the cam mechanism rotates to the second position;
wherein the fifth protrusion impels the third slider and opens the third valve when the cam mechanism rotates to the third position;
wherein the seventh protrusion impels the fourth slider and opens the fourth valve when the cam mechanism rotates to the fourth position;
wherein the second, fourth, sixth, eighth protrusions impel the first, second, third and fourth sliders and open the first, second, third and fourth valves when the cam mechanism rotates to the sixth position.

15. The inkjet printer as claimed in claim 14, wherein when the cam mechanism rotates around the central axis to the fifth position, the first slider separates from the first and second protrusions, the second slider separates from the third and fourth second protrusions, the third slider separates from the fifth and sixth protrusions, and the fourth slider separates from the seventh and eighth protrusions, such that the first, second, third and fourth valves are closed.

16. The inkjet printer as claimed in claim 14, wherein the first and second protrusions are spaced 60° apart, the third and fourth protrusions are spaced 120° apart, the fifth and sixth protrusions are spaced 180° apart, and the seventh and eighth protrusions are spaced 240° apart.

17. The inkjet printer as claimed in claim 1, further comprising a motor and a detection circuit, wherein when the motor rotates the cam mechanism at a constant speed to impel the first slider in the first direction, and the detection circuit detects the first position according to variation of rotational speed of the cam mechanism or driving torque of the motor.

18. The inkjet printer as claimed in claim 9, further comprising a motor and a detection circuit, wherein when the motor rotates the cam mechanism at a constant speed to impel the first, second, third, and fourth sliders in the first direction, the detection circuit detects the sixth position according to variation of rotational speed of the cam mechanism or driving torque of the motor.
